(19) United States
(12) Patent Application Publication
(10) Pub. No.: US 2011/0184649 A1
(43) Pub. Date: Jul. 28, 2011

(54) Method of Assessing Risk in an Area

(75) Inventor: Eran Ofek, Modi'in (IL)

(73) Assignee: Physical Logic AG, Zug (CH)

(21) Appl. No.: 11/954,574

(22) Filed: Dec. 12, 2007

Related U.S. Application Data
(60) Provisional application No. 60/870,332, filed on Dec. 15, 2006.

(51) Int. Cl. G06F 19/00; G06F 17/18

(52) U.S. Cl. 702/19; 702/27; 702/179; 702/23

(57) ABSTRACT

A method and system for the evaluation of the probability for the presence of suspicious materials is presented. The proposed system will be able to continuously monitor a large area or a gate passage, without a specific need for a manual full-body search or manual inspection or the use of sniffers or sniffing dogs (although the system can be embedded within such a gate), and will allow to detect suspicious materials, not by identifying the specific material, but rather by at least one of the chemical and/or physical analysis of the commonality of all detected materials against the statistical accumulation database of all material properties that were presented to the system in the past.

### CROSS REFERENCE TO RELATED APPLICATIONS

The present application claims priority to the U.S. provisional application of the same title filed on Dec. 15, 2006, having application Ser. No. 60/879,332, which is incorporated herein by reference.

### BACKGROUND OF INVENTION

The present invention relates to the methods of assessing risk in a specific area based on identifying suspicious materials (dangerous or illicit materials for example) either carried by people or otherwise.

Prior methods of detecting dangerous materials involve either visual inspection, either directly by hand searching, or indirectly through X-ray or other non visual imaging methods. Alternatively, technology is available to detect specific dangerous compounds, and in particular explosives, by air samples of vapors or minute particles. Thus, particularly hazardous materials, which might escape visual or x-ray inspection because they appear as innocuous solids or have the same density as other safe materials, can be detected.

Other technologies utilize a combination of X-ray detection with other forms of spectral analysis. Examples of such technology include, for example and without limitation U.S. Pat. No. 6,928,131 for Method for detecting an explosive in an object under investigation to Olshansky, et al. issued Aug. 9, 2005, which is incorporated herein by reference. This method for detecting an explosive in an object under investigation involves a combination of initial X-ray irradiation of the object under investigation and imaging followed by subsequent thermal neutron irradiation of the area with the unidentified article; recording gamma-ray quanta having the energy of 10.8 MeV and cascade gamma-ray quanta with energies of 5.534 and 5.266 MeV and making a decision in the event the threshold value of overall gamma-ray intensity is exceeded.

Other types of sensors devised are broadly describe in U.S. Pat. No. 7,109,859 for a Method and apparatus for wide area surveillance of a terrorist or personal threat to Peeters issued Sep. 19, 2006

The current need in homeland security is to be able to detect the presence of suspicious materials in a non-intrusive way, within a large crowd or gates and in real-time.

Current systems, such as used in airports (“security gates”) create a bottleneck and delay people and are not effective. For example, U.S. Pat. No. 7,119,682 for a Facility and method for crowd screening and protection to Fisher issued Oct. 10, 2006, which is incorporated herein by reference teaches the isolation of individuals suspected of having hazardous materials. It suggests as material and substance detectors, biometric and physiological sensors, and/or a combination thereof. For example, metal, explosives and drug detectors, may be combined with body condition detectors pertaining to the corporeal reactions of an excited, frightened, or possibly drugged potential terrorist. If desired, such devices may include video and IR cameras, Nuclear Quadrupole Resonance (NQR) detectors, drug “sniffer” devices, pulse rate and body temperature sensors, pupil dilatation and eye-blinking measuring equipment, sweat discharge measurement, face recognition, and the like.

Current systems detect metals and specific chemicals only. U.S. Pat. No. 6,978,657 for a Portable chemical detection system with integrated preconcentrator to Baumann, et al. which issued on Dec. 27, 2005 is also incorporated herein by reference. A portable system for the detection of chemical particles such as explosive residue utilizes a metal fiber substrate that may either be swiped over a subject or placed in a holder in a collection module which can shoot a jet of gas at the subject to dislodge residue, and then draw the air containing the residue into the substrate. The holder is then placed in a detection module, which resistively heats the substrate to evolve the particles, and provides a gas flow to move the particles to a miniature detector in the module.

U.S. Pat. No. 6,967,103 for Apparatus and methods for detecting explosives and other substances to Schwartz, et al. issued Nov. 22, 2005 is also incorporated herein by reference. An explosive detector utilizes an array of molecularly imprinted polymer (MIP) coated, bifurcated fiber optic cables to form an image of a target molecule source. The detector can be used to detect multiple and/or non-explosive targets by varying the MIP coating. It should also be appreciated that many methods of detecting explosive do not rely on the measurement of the hazardous compound itself, but rather unique compounds or taggants that authorized manufactures add to the explosives to facilitate detection.

Other methods of detecting explosives, taggants and other compounds of interest utilize terahertz radiation; such technology being described in U.S. Pat. No. 6,605,808 to Mickan et al. for a Diagnostic apparatus using terahertz radiation, issued on Aug. 12, 2003 is also incorporated herein by reference. Another patent describing an apparatus deploying terahertz radiation is U.S. Pat. No. 6,865,014 to Ciesla et al. for Apparatus and method for investigating a sample, issued Mar. 8, 2005 is also incorporated herein by reference.

Other methods of detecting known hazardous compounds are disclosed in U.S. Pat. No. 7,129,482 for Explosives detection using differential ion mobility spectrometry to Miller, et al. which issued Oct. 31, 2006, and is also incorporated herein by reference.

Unknown chemicals and materials are not detected unless a full body search is performed (in case of a person), or a full inspection is performed (in the case of a container, package, baggage etc). In that case, only visible packages are detected and not the residuals of illicit drugs or hazardous materials. However, such technology like those described above to be effective require expensive equipment and generally a long sampling time per individual or object that is evaluated.

It would be far better to have a means to identify and select the most suspicious material profile in an area (whether on individuals or packages) for a more complete evaluation by a combination of the best available technology, including ion mobility spectrometers, miniature ion mobility spectrometers, electron capture detectors, mass spectrometers, chemiluminescence-based systems, ChemLab-on-a-Chip detectors, and ChemLab-on-a-Chip detectors comprising chemiresistor arrays and the like

It is therefore a first object of the present invention to provide a means to rapidly detect potentially suspicious material profiles in an area, carried by persons or on specific items, and after identifying the suspicious material, extensively and precisely test the carrier or holder of that suspicious material.

The current need in homeland security is to be able to detect the presence of suspicious materials in a non-intrusive way, within a large crowd, area or gates and in real-time.

### SUMMARY OF INVENTION

In the present invention, the first object is achieved by sampling a region or space corresponding to at least one person, their possessions or a cargo hold, determining the chemical, biological and or radiating composition of the sample, comparing the sample to a known database of such samples, determining if the deviation from the known database is statistically significant, and then if the deviation is statistically significant, subjecting the suspicious sample and its carrier to additional screening measures to access or eliminate the threat.

The proposed system will be able to continuously monitor a large area or a gate passage, without a specific need for a manual full-body or extensive inspection search or the use of sniffers or sniffing dogs (although the system can be embedded within such a gate), the system will allow the detection of suspicious materials, not by identifying the specific material, but rather by analyzing the commonality of all detected materials against the statistical accumulation database of all material properties that were presented to the system in the past.

Thus, by comparing the global signature of all of the materials that are presented to the sensors, against the list of all of the materials that are present in the database, in order to calculate how “common” or how “unique” each material from the sampled area is against the historical database of all sampled materials in that area or gate. A material with a very low number of occurrences detected passing through a security gate or in the sampled area, would probably be an illicit material that is probably worth a more extensive search process.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a flow chart illustrating one aspect of the method.

### DETAILED DESCRIPTION

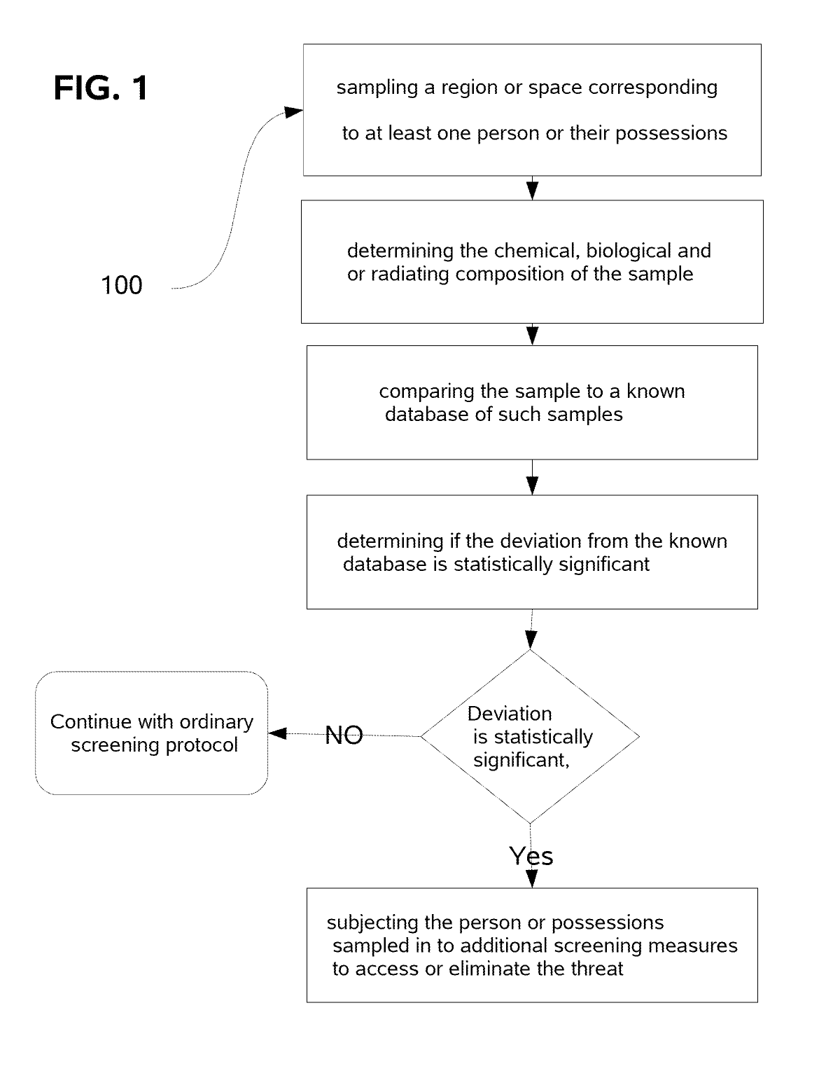

Referring to FIG. 1, there is illustrated therein a new and improved Method of Assessing Risk in an Area, generally denominated 100 herein.

Current systems of security screening of vulnerable locations, such as used in airports (“security gates”), border entry or sea-port screening frequently create bottlenecks and delay people and cargo because it is not cost effective to deploy enough security screeners or border control agents to keep up with peak demands or cargo and/or travelers.

Further, depending on the search and screening technology used, they may not be effective, as current systems are generally designed to detect metals and specific chemicals only.

Unknown chemicals and other hazardous materials may not be detected unless a full body search or a manual inspection is performed, as it is frequently too time-consuming or expensive to non-invasively test each package, cargo container or individual for all known illicit substances. Generally, only visible packages are detected and not the residuals of illicit drugs or hazardous materials.

In accordance with the present invention as shown in FIG. 1, an initial sampling of a region or space for example in a volume corresponding to at least one person or their possessions is made. The chemical, biological and or radiating composition of this sample is then determined. Next, the composition/characteristic of this sample is compared to a known database of such samples. Such a known database may be generated say by first sampling hundreds or even thousands of travelers, packages etc to determine sample or characteristics that are common to say at least 90 or 95% of such samples. Such a phase can also be called a “learning” phase.

It should also be appreciated by one who is skilled in the art, that this method can also be used to sample larger areas which include larger numbers of potential threats such as air-port terminals, entrance gates, sea-ports etc.

Thus, in the next step in the process 100 shown in FIG. 1 a determination is made if the deviation from the known database is statistically significant. If the deviation is statistically significant, then the person or possessions sampled in the first step is subject to additional screening measures to access or eliminate the threat. Those deemed not significant continue to be screened, if at all under the ordinary screening protocol. While the deviation is saved within the database as part of the systems' learning ability.

Thus, the above detection scheme is such that allows the system, after an initial learning and training phase, to be able to detect abnormal profiles of scanned elements in the environment and issue an appropriate alert.

As stated, the system has an initial learning and training phase and an operational phase. In the learning phase, the system scans all elements (personnel, packages, cargo containers etc) that are in the effective scanning area.

By scanning we intend to mean obtaining a representative sample of a person or object and all manner of substances it contains or emits or ejects such as vapors, particulate and the like.

The presented method can be combined with other various methods for detecting specific materials or specific methods for naming materials based on specific signal peaks. The detection and analysis methods that may be used can include methods which detect any physical phenomenon such as: radiation, signal reflection, deflection, absorption, transparency, conductivity, resistance etc. For example, each material which is scanned by electromagnetic radiation, such as UV, visible, near infrared, infrared and THz radiation absorbs radiation at specific wavelengths. By analyzing the return radiation a system can detect the presence of specific materials.

However, the system can also operate in a mode wherein if a statistically significant portion of the sample cannot be uniquely identified as to its actual composition to assure that no hazardous materials or contraband is present, then the person or objects sampled in the first step is subject to additional screening measures to access or eliminate the threat.

The system can utilize any standard or subsequently developed method of chemical analysis to identify the chemical composition of the sample, such as ion mobility spectrometers, miniature ion mobility spectrometers, electron capture detectors, mass spectrometers, chemiluminescence-based systems, ChemLab-on-a-Chip detectors, and ChemLab-on-a-Chip detectors comprising chemiresistor arrays. It is preferable then that whatever method is used to detect known or unknown substances can chromatographically separate each substance and then uniquely identify as well as quantify the substances concentration.

The method of analyzing the representative sample may include spectroscopy of all manners, including without limitation combined gas chromatography and mass spectroscopy of the chromatographic effluent.

To the extent that the separation is not complete and there is some spectral overlap, such as in the UV, IR, NIR or Far IR or Raman spectra then various known methods of spectral deconvolution may be used, as well as that taught in U.S. Pat. No. 5,945,676 for a Method and apparatus for multi-spectral analysis in noninvasive NIR spectroscopy issued to Khalil, et al. Aug. 31, 1999 that is incorporated herein by reference.

The method does not exclude the use of detectors intended to identify known hazardous substances, chemical and high-explosive agents, biological agents, radiological agents, and nuclear material, as well as other types of contraband such as illegal substances, embargoed material or stowaways, such sensor could include the Joint Biological Point Detection System (JBPDS) manufactured by Intellitec of Jacksonville, Fla., designed to detect and identify a plurality of biological pathogens. The sensors may also include other similar types of fully-integrated, detecting and identifying biological agent sensors, utilizing automated immunoassay methods that include the 4WARN manufactured by General Dynamics Canada of Calgary, AB, Canada; Portal Shield or JBREWS manufactured by Sentel of Alexandria, Va.; or others. Some sensors could also take the form of a PCR-Nucleic Analysis system such as those manufactured by Cepheid of Sunnyvale, Calif., or Idaho Technologies of Salt Lake City, Utah. Some sensors could also take the form of detectors that serve only to detect the presence of biological material in particles in the analyzed air stream, like the BIONI, manufactured by Pacific Scientific Instruments of Grant's Pass, Oreg.; the Biological Aerosol Warning System Tier III developed by MIT Lincoln Laboratories in MA; the UV-APS, manufactured by TSI Inc. of St. Paul, Minn.; the UV-FLAPS and BARTS manufactured by General Dynamics Canada of Calgary, AB, Canada; or others. The sensors could also include a particle detector based system like the Biological Aerosol Warning System Tier I, manufactured by Lockheed Martin of Manassas, Va.

In addition, a simple collector, such as a filter or a BioCapture system manufactured by Mesosystems, Inc of Kennewick, Wash.; or other type of particle capture device could also be part of the sensor suite. Such a unit would be intended to capture particles for later laboratory analyses including culturing, immunoassay, and PCR-nucleic acid methods. Such a unit would also be useful for forensic purposes and for the collection of evidence. The sensor suite could also include one or more chemical warfare agent sensors such as ion mobility spectrometers including the ChemPro 100 or the M-90 manufactured by Environics Oy of Mikkeli, Finland, or similar sensors manufactured by Graseby lonicics and ETG; surface acoustic wave sensor based devices including the JCAD sensor, manufactured by BAE Systems of San Antonio, Tex.; the HAZMATCAD, manufactured by Microsensor Systems Inc. of Bowling Green, Ky.; the Micro Chem Lab on a Chip manufactured by Sandia National Laboratories in Albuquerque, N. Mex.; the SnifferSTAR sensor manufactured by Lockheed Martin of Manassas, Va. and Sandia National Laboratories, or others. They could also take the form of explosives sensors, such as those manufactured by Ion Track Instruments of MA or Smith's Sensors of NJ (formerly Barringer), or contraband drugs sensors manufactured by the latter two manufacturers. The sensors could also include sensors for radiological particles in air, including Geiger counters and other radiological detectors, such as broad beam single scintillation detectors, narrow beam single scintillation detectors, dual scintillation detectors and neutron detector arrays.

It would be particularly of interest to identify nitrogen compounds, or combinations of nitrogen with other elements in particular ratios that are common in explosive substances.

In other modes of operation, the system can continuously scan the effective scanning area (the size of that area is determined by the specific type of scanning hardware and the specific needs of the area scanned and the type of objects found in said area). In the initial learning phase, the system saves the spectral patterns and/or chromatographic data in a database. It is anticipated that in certain embodiments, depending on the type of spectroscopy and chemical analysis it is not necessary to absolutely determine the specific materials or composition of a sample.

The area scanned may correspond to a room with multiple persons, who can later be individually screened or one by one screening as either person or their belongings as they pass through a corridor or region.

When the database has reached a certain size, and contains a specific amount of samples which is enough for effective statistical analysis, a standard profile is generated. The standard profile describes what kinds of materials are usually detected on a normal, i.e. non-suspicious object (person, package etc). This is based on the assumption that most if not all non-suspicious objects do not contain materials which are the types of materials which are considered bomb components etc. It should also be appreciated, that for some methods, the standard profile does not need to include the specific kinds of materials, but rather, the standard type of sample which is common in a large enough percentage of targets samples.

Once the system has completed its learning phase it begins its operational stage. In the operational stage, the scan profile of each scanned object in the effective scanning area is compared to the “learned” standard profile.

Known dangerous or hazardous substances are of course excluded from what might be considered a standard profile. However, some substances may be routinely found in miniscule quantities, but be hazardous, and therefore suspicious, if present in quantities or in the presence of other compounds.

If any deviation from the standard profile is detected, the percentage amount of the deviation percentage determines the level of alert that the system will issue. If, for example, a sample deviates 2% from the standard profile then the system will just mark it as a suspicious object of low priority. If, however, a sample deviates from the standard profile by a substantial percentage, 25% for example, then the system will issue a high priority alert for that object.

Such deviations of statistical significance might include, for example, the amount of nitrogen containing compounds compared to other compounds, or the amount of unidentifiable compounds compared with identified compounds. Alternatively, it may be of practical value to evaluate deviations in the amount of more volatile organic compounds detected, in comparison to the usual amount, as well as type of compounds that may be found on other objects.

As this is a statistical based method, the method allows any system implementing it to continue to improve the standard profile, but adding new spectral characteristics that become more statistically common to the standard profile.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A method of threat protection, the method comprising the steps of:
a) sampling a region or space corresponding to an effective area for sampling objects of certain sizes and shapes,
b) determining the chemical, biological and or radiating characteristics of the sample,
c) comparing the sample to a known database of such samples,
d) determining if the deviation from the known database is statistically significant,
e) subjecting the objects sampled in a said previous sampling step to additional screening measures to access or eliminate the threat.

2. The method of claim 1 wherein the effective area is a cargo container.

3. The method of claim 1 wherein the effective area encompasses a plurality of persons.

4. The method of claim 1 wherein the effective area encompasses a person and their belongings.

5. The method of claim 1 wherein the effective area encompasses a person.

6. The method of claim 1 wherein said step of determining includes determining the amount of nitrogen containing compounds.

7. The method of claim 8 wherein said step of comparing includes comparing the amount of nitrogen containing compounds to those that do not contain nitrogen.

8. The method of claim 1 wherein said step of determining includes determining which compounds are identifiable.

9. The method of claim 8 wherein the comparison includes comparing the amount of unidentifiable compounds to those that are identified.
